(19) United States
(12) Patent Application Publication
(10) Pub. No.: US 2007/0281059 A1
(43) Pub. Date: Dec. 6, 2007

(54) Carbonated beverage national school lunch meal

(76) Inventor: Leon Curtis Smith, Dallas, TX (US)

Correspondence Address: LEON CURTIS SMITH, 5637 EMROSE TERRANCE, DALLAS, TX, 75227, US

(21) Appl. No.: 11/592,640

(22) Filed: Nov. 3, 2006

Related U.S. Application Data
(60) Provisional application No. 60/810,385, filed on Jun. 2, 2006.

(51) Int. Cl. A23L 1/30

(52) U.S. Cl. 426/311; 426/534

(57) ABSTRACT

A process for preparing, designing, making and flavoring a shelf stable carbonated beverage by taking a commercial brand name product and improving it by adding foodstuff nutrients to make it an American meal. When combined they meet the predetermined requirements of the National School Lunch Program, the United States Department of Agriculture, and the Dash Eating Plan food intake requirements as defined in present invention. The beverage Said meal takes an existing commercial product, an example is a candy bar, and adds the necessary food stuff components to the candy bar such that the final product meets the food intake requirements for an of said_American meal. The method of producing a shelf stable liquid foodstuff product of the present invention comprises injecting under pressure carbon dioxide gas or a mixture of gases into said foodstuff at low temperatures. Said beverage remains shelf stable in packaging until opened.

### FIELD OF INVENTION

The present invention relates, specifically, to the National School Lunch Program requirements. It also zeros in on the daily food intake requirements of the United States Department of Agriculture and Dash Food Plan. Said invention comprises a method of preparation, processing, and forming food stuff into a shelf stable carbonated, nutritional, tasteful and flavored beverage meal design with a commercially proven brand name taste additive. Said invention meets all of the food intake requirements of the National School Lunch Program, as well as the dietary guidelines for Americans.

A number of U.S. patents have been issued for numerous related beverages:

U.S. Pat. No. 5,879,737 to Ashourian, issued on Mar. 9, 1999 discloses a process for producing a shelf stable, pourable product from fresh and processed fruits, fruit purees and fruit juices. The product is produced by fragmentation on intact fruit cells by homogenization of fruit puree juice mixtures. More than 61% of the intact fruit cells are to fragmented during homogenization to form a small cell fragment. The resulting products are pourable, spreadable, shelf-stable, and free of sedimentation for six months.

U.S. Pat. No. 4,737,367 to Langer et al., issued on Apr. 12, 1988, is directed to a fruit-flavored beverage which is predominantly a mixture of citrus (at least half as orange juice) and tropical fruit juice (at least half as pineapple juice) and having high concentrations of vitamins to satisfy the recommended daily allowance of vitamins in a single serving of a drink. The mixture of citrus fruit juices and tropical fruit juices in proportions described in the invention mast the unpalatable taste of added vitamins. Individually apricot, peach and banana as well as grape, apple, and pear juices do not mask the taste of added vitamins.

U.S. Pat. No. 6,899,905 to Posise et al., issued on May 31, 2005, is directed to tasty, ready to eat nutritional foods that provide a balanced mix of amino acids, fats, and carbohydrates are disclosed. Processes for making and methods of the using said tasty, ready-to-eat nutritional foods are disclosed. The nutritious foods of the invention are formulated and processed.

U.S. Pat. No. 6,383,546 to Powrie et al., issued on May 7, 2002 discloses a process of composing a smoothie. The invention pertains to the formulation and process for producing a universal fruit base, which is an apple mash-polysaccharide mixture to which fruit puree(s) and optionally concentrated fruit juice(s) are to be added to from beverage concentrates. The beverage concentrates are to be diluted with water and /or fruit(s) to create supreme, distinctive, refreshing, creamy, smoothie, thick, non gummy and non settling fruit beverages. A wide variety of ingredients such as protein foods, coffee, tea, cocoa, nutrients, natural and artificial flavors, sweeteners and botanicals may be added for flavor, nutritional and health appeal.

The use of heat treated product is well established in the art. It is well known that preheating milk, milk related, and fruit product and then heating the preheated product intensively for a short period of time, i.e. approximately 2-5 seconds to temperatures documented for pasteurization for specific time periods will allow said product to be shelf stable and safe for human consumption. Typical processes are set forth in the U.S. Pat. No. 3,973,048 to Tera Pak Development SA (1976), U.S. Pat. No. 6,163,532, to Parmalat S.p.A. (2000), U.S. Pat. No. 4,921,717 to Milk Marketing Board (1990), U.S. Pat. No. 607,362, to FWH Graeff (1898), U.S. Pat. No. 1,570,975 to D. Sweeney (1926), U.S. Pat. No. 6,761,920 to Excited Beverage Co. Ltd (2004) and U.S. Pat. No. 5,955,136 to PepsiCo Inc (1999).

### OBJECTIVES AND ADVANTAGES OF INVENTION

1. To provide a method for carbonation of pre-heated and pressurized heat treated mixed food stuff products and combinations of pre-heated and pressurized heat treated mixed food stuff products and to provide a pre-heated and pressurized heated treated carbonated mixed food stuff product that may be flavored with proven and popular commercial brand named products.

2. To provide a method to aerate or carbonate pre heated pressurized heat treated mixed food stuff with suitable gas or mixture of gases in a suitable package whereby the pre heated and pressurized heat treated mixed food stuff products remains carbonated in package for a reasonably long shelf life until opened and on refrigeration is required.

3. To provide a method of aerating or carbonating pre heated and pressurized heat treated mixed food stuff by introducing a gas or a mixture of gases such as carbon dioxide into a preheated and pressurized heat treated mixed food stuff under pressure, maintaining the pre heated and pressurized heat treated mixed food stuff in an aerated or carbonated state and packaging the aerated or carbonated pre heated and pressurized heat treated mixed food stuff into a package. Typically, the packaging includes glass bottles, aluminum cans, cartons of paperboard and plastic containers.

4. To take a commercial brand name product and improve it by adding the missing vitamins, calories and nutrients such that combined and carbonated they meet the requirements of the National School Lunch Program, the Dash Eating Plan, the United States Department of Agriculture food intake for American, and various other meal plans and the end product taste like the commercial brand product.

Several additional advantages noted of present invention are:

(1) It is specific to the daily food intake requirement of Americans.

(2) It is specific to commercially defined and proven taste.

(3) It takes a commercially proven product and adds the missing nutrients such that the final product meets the daily food intake requirement of the national school lunch program as well as tasting like the commercially proven product.

(4) It can be labeled as a “fast food”. You can take it everywhere.

(5) It can be consumed as a “hot” beverage or as a “cold” beverage.

(6) It aids those individuals that have trouble chewing.

(7) It allows an individual to count calories better.

(8) It eliminates the need for cooking everyday.

(9) It is a cost saving as related to electricity and gas stoves.

(10) It has potential military usage.

(11) It has potential hospital usage.

(12) It has potential imprisonment system usage.

(13) It has potential retirement home system usage.

(14) It has potential Salvation Army/Red Cross usage.

### BACKGROUND OF THE INVENTION

The carbonation of liquid beverages extends into antiquity. The ancient Egyptians produced a carbonated beverage similar to present day beer and the production of carbonated wines extends beyond historical records. Thus this is a well known art. It has been known for centuries that the carbonation of a beverage can significantly affects the taste and mouth feel of that beverage. Efforts have been in the art to artificially carbonate beverages, as opposed to natural carbonation which occurs during beer making, wine making, and in naturally carbonated waters. Artificially carbonated beverages have long been a popular beverage both for consumption and for mixing with other beverages such as producing an alcoholic mixed drink.

Consumers for years have relished the taste of the carbonated beverage. An example is “Coke Cola” which is the worlds largest selling beverage. Carbonated beverages out sell non-carbonated beverages three (3) to one (1) worldwide. The present invention of a carbonated beverage that meets the requirements of National School Lunch Program meal that is shelf stable lends itself perfect to the world of carbonated beverages.

Carbonated beverages have been restricted to no,low, medium, or very high nutritional beers, Wines, milks, waters, fruits, and various forms of other drinks. Non of them can be labeled a beverage meal that meets the nutritional requirements that are documented under the NATIONAL SCHOOL LUNCH PROGRAM, the USDA and the Dash Eating PLAN food intake guideline for Americans and made from a proven commercial brand named product.

Americans are not eating enough healthy meals. The meals in question are defined by the USDA's Dietary Guidelines for Americans. It is imperative that something be done about it immediately. Americans are “junk food junkies”. And because of it America has become a nation of overweight and obese people. In the United States obesity has risen at an epidemic rate during the past 20 years. The latest results from the 1999-2005 National Health Nutrition Examination survey (NHANS) using measured heights and weights, indicate that a estimated 65% of American adults 20 years and older are either overweight or obese. This equates to over 127,000,000 Americans. The increase is not limited to adults. The percentage of young people who are over weight has more than tripled since 1980. Among children and teenaged Americans aged 6-19 years old, 16% are considered overweight. This equates to over 9,000,000 young people as overweight. All of the current data indicates that the situation is worsening rather than improving. The dieting programs are not enough. Americans need a change in their approach to food in take. Overweight and obesity are winning the war. Complication of the obesity epidemic include high cholesterol, high blood pressure, type 2 diabetes, mellitus, coronary plaque formation, and serious psychosocial implications.

Obesity is dramatically increasing not only in American children and adults, but also in every country in the world that has adopted similar cultural habits. The World Health Organization now considers obesity to be a global epidemic and a public health problem as more countries become westernized.

Approximately 300,000 deaths each year in the United States may be attributable to obesity. Overweight and obesity and their associated health problems have a significant economic impact on the U.S. health care system. According to a study, national health cost attributed to both overweight and obesity, medical expenses accounted for 9.1% of the U.S. medical expenditures in 1998 and may have reached as high as $78.5 billion, $92.6 billion in 2002. The latest study (January/2004) by the Pediatrics Committee on School Health has this number a $100 billion. Approximately half of the cost were paid by medicate and Medicare. Medicare has now officially declared obesity to be a disease, opening the floodgates for obesity treatment to be covered by Federal and private health insures. It is now forecasted that the health cost associated with obesity will double by the year 2007, to $200 billion.

Modern day people live at a hurried pace. They have more things to do and less time to do them. They no longer have time to sit down and have a nutritional home cook meal. This leads them to junk food. This also leads them to eat at fast food restaurants. It is here Americans are making the poor choices for nutritional and balanced meals. It is here they forget about the USDA's food guidelines. As documented their choices are leading them down the path of overweight and or obesity, both of which are putting them at health risk.

There is a definite and immediate need in the food market for the present invention as it employees an additional method of preparing a nutritional meal. The present invention meets all requirements for food in takes that are outlined in the National School Lunch Program. The present invention fits perfectly in the fast food market. Their needs to be a beverage meal that also meets the USDA and DASH food intake requirements. It is the objective of present invention to provide a tasteful and flavorful beverage meal that fills the gap in the nutritional food market. It is also the objective of the present invention to help improve the long turn health requirements of all individuals thus reducing medical cost as it relates to food intake.

### SUMMARY OF THE INVENTION

Briefly described, the present invention comprises a process for making, or preparing, a shelf stable carbonated, tasteful and flavored beverage meal that meets all the National School Lunch Program requirements, of food in take. Said requirements are further defined by the USDA and DASH publication Dietary Guidelines for Americans. Simply put Americans will be overwhelmed to get a meal that combines proven great taste with a balanced nutritional profile in beverage form. It is a different and unique way of packaging a complete meal. The idea of a beverage meal that taste like a cheeseburger, a Coke Cola Zero, a roast beef sandwich, a Diet Pepsi, a pizza, a Diet Dr Pepper, and etc., will change the way Americans approach food intake. More important are the health issues that the beverage meal addresses. The overwhelming truth is, the prior art or present method(s) is failing and failing drastically with no end in sight. To summarize, Americans love food. Americans love to drink. And both must taste good. The beverage meal has all three components, therefore it fits in the field of things Americans love.

Meal structure for lunch:

In the National School Lunch Program, meals are required to have three meal items for lunch. There are three categories.

1. Entree, one serving; a combination of food or single food item offered as the main course;

2. Milk, one serving; fluid as a beverage must be offered, but no specific amount is required. Milk can be flavored or unflavored.

3. Side dish, one or more servings; any other meal item offered is considered a side dish unless it is a condiment.

4. Offer versus serve; at least three meal items must be offered. A entree, a fluid milk, and a side dish. A student must select at least two of the three. One of the two must be an entree. If there are more than three items of the meal unit, students may decline on more than two items of the meal items. The student can never decline the entree.

Meal structure for breakfast:

National School breakfast Program, meals are required to have two meal items for breakfast. There are two categories;

1. Milk, one serving; fluid as a beverage, must be offered but no specific amount is required. Milk can be flavored or unflavored.

2. Side dish, one or more serving; any other item offered is considered a side dish unless it is a condiment

3. Offer versus serve; student may decline a maximum of one meal item out of the two or more items offered.

### EXAMPLE 1

Coke Cola Cherry beverage meal.

In accordance with the preferred embodiments of the present invention, the following food stuff ingredients, by measurement/weight, were combined and mixed together at room temperature using a Hamilton Beach model #58754 blender to form a liquid and then carbonated to make a beverage meal that meets all the requirements of the National School Lunch Program.

1. Milk group; 1 cup of yogurt (Great Value's cherry low fat yogurt w/other natural flavors).

2. Vegetable group; 0.83333 cup of mixed vegetables (Flav-R-Pac's frozen mixed vegetable package).

3. Grain group; 2 slices of bread (Great Value's whole wheat bread).

4. Meat and beans group; 1.8333 pasteurized egg (sunny meadows')

5. Fruit group; 0.6666 cup cherry tidbits (Del Monte's canned cherry tidbits)

6. Oil group; 2 tablespoon of low-fat mayonnaise.

7. Discretionary calorie allowance group; none.

8. Flavor or taste group; 12 oz of Coca Cola Cherry, soft drink (Coca Cola Company)

9. Above food groups are mixed to liquid form, per said claim 4.

10. Mixed foodstuff carbonated per said claim 28.

### EXAMPLE 2

The lime-lemon beverage meal.

In accordance with the preferred embodiments of the present invention, the following meal ingredients, by measurement/weight, were combined and mixed together at room temperature using a Hamilton Beach blender #58754 blender to form a liquid and then carbonated to make a beverage meal that meet all requirements of the National School Lunch Program.

1. Milk group; 1 cup yogurt (Great Value's blended lemon-lime low fat yogurt).

2. Vegetable group; 0.83333 cup of mixed vegetables (Flav-R-Pac's canned mixed vegetables).

3. Grain group; 2 cups ready-to-eat cereal (Malt-0-Meal Company's crispy rice).

4. Meat and beans group; 1.8333 pasteurized egg (Sunny Meadows).

5. Fruit group; 0.6666 cup mixed fruit (Del Monte's fresh cut lemon and lime tidbits).

6. Oil group; 2 tablespoon of low fat mayonnaise.

7. Discretionary calorie group; ⅜ ounces of lemonade.

8. Flavor and taste group; 12 oz of Diet Lemon-Lime soft drink (Sam's Choice/Walmart).

9. Above food groups are mixed to form liquid, per said claim 4.

10. Mixed foodstuff carbonated per said claim 28.

### EXAMPLE 3

The coffee beverage meal.

In accordance with the preferred embodiments of the present invention the following mean ingredients, by measurement, weight, were combined mixed together at room temperature using a Hamilton Beach blender #58754 to form a liquid and then carbonated to make a beverage meal that meets all the requirements of the National School Lunch Program.

1. Milk group; 1 cup yogurt (Great Value's blended plain low fat yogurt).

2. Vegetable group; 0.83333 cup of mixed vegetables (Flav-R-Pac's frozen mixed vegetables).

3. Grain group; 2 cup ready-to-eat cereal (Malt-O-Meal's Scooters).

4. Meat and beans; 1.83333 pasteurized egg (Sunny Meadows).

5. Fruit group; 2 bananas (Del Monte Company).

6. Oil group; 2 tablespoons of low fat mayonnaise.

7. Discretionary calorie group; none.

8. Flavor and taste group; 12 oz of fresh brewed Sanka coffee.

9. Above food groups are mixed to form a liquid, per said claim 4.

10. Mixed liquid foodstuff carbonated per said claim 28.

### EXAMPLE 4

The coke zero, cheeseburger, french fry beverage meal (three individual portions that equate to (1) full meal that meets the National School Lunch Program)

In accordance with the embodiments of the present invention the following means ingredients, by measurement/weight, were combined mixed together at room temperature using a Hamilton Beach blender #58754 to form a liquid and carbonated to make a beverage meal the meets all the requirements of the National School Lunch Program.

Cheeseburger(entree).

1. Milk group; ⅔ cup milk (Borden's 1% nonfat dairy milk).

2. Vegetable group; 0.2780 cup of mixed vegetables.

3. Grain group; 0.667 cup ready to eat cereal (Malt-O-Meal's Scooters).

4. Meat and beans; 0.611 cup of pasteurized egg (Sunny Meadows co.).

5. Fruit group; 0.222 cup canned fruit cocktail.

6. Oil group; 0.667 tablespoon of low fat mayonnaise.

7. Discretionary calorie group; none

8. Flavor and taste group; one (1) Mc donald's cheeseburger.

9. Above food groups mixed to puree form, per said claim 4.

10. Mixed liquid foodstuff carbonated per said claim 28.

Slim-Fast smoothie (flavored milk)

1. Milk group; 4.0 oz of milk (Carnation instant nonfat dry/water added)

2. Vegetable group; 0.2780 of mixed vegetables (Flav-R-Pac's canned mixed vegetables)

3. Grain group; 0.667 cup ready to eat cereal

4. Meat and beans; 0.611 cup of pasteurized egg (Sunny Meadows Co.)

5. Fruit group; 0.222 cup of canned strawberry fruit.

6. Oil group; 0.667 tablespoon low fat mayonnaise.

7. Discretionary calorie group: none

8. Flavor and taste group; 10 oz of Slim-Fast smoothie strawberry flavored soft drink.

9. Above food groups are mixed to liquid form, per said claim 4.

10. Mixed foodstuff carbonated per said claim 28.

French fries (side dish)

1. Milk group; 0.333 cup low fat yogurt.

2. Vegetable group; 0.2780 of mixed vegetables

3. Grain group; 2 slices of whole wheat bread (Wonder Bread)

4. Meat and beans group; 0.611 of pasteurized egg (Sunny Meadows Co.)

5. Fruit group; 0.222 cup of fruit cocktail.

6. Oil group; 0.667 tablespoon of low fat mayonnaise.

7. Discretionary calorie group; none.

8. Flavor and taste group; french fry flavored soft drink per said claim 14.

9. Above food group mixed to liquid form, per claim 4.

10. Mixed food stuff carbonated per said claim 28.

Whereas this invention has been described in detail with particular reference to its most preferred embodiments, it is understood that variations and modifications can be effected within the spirit and scope of the invention, as described herein before and as defined in the appended claims. The corresponding structures, materials, acts, and equivalents of all means plus function elements, if any, in the claims above are intended to include any structure, material, or acts for performing the functions in combination with other claimed elements as specifically claimed.

### BRIEF DESCRIPTION OF THE DRAWINGS

FIG. 1 shows a general flow chart of a typical embodiment of the invention.

FIG. 2 shows a flow chart of the preferred embodiment of the invention.

### DETAILED DESCRIPTION OF THE DRAWINGS

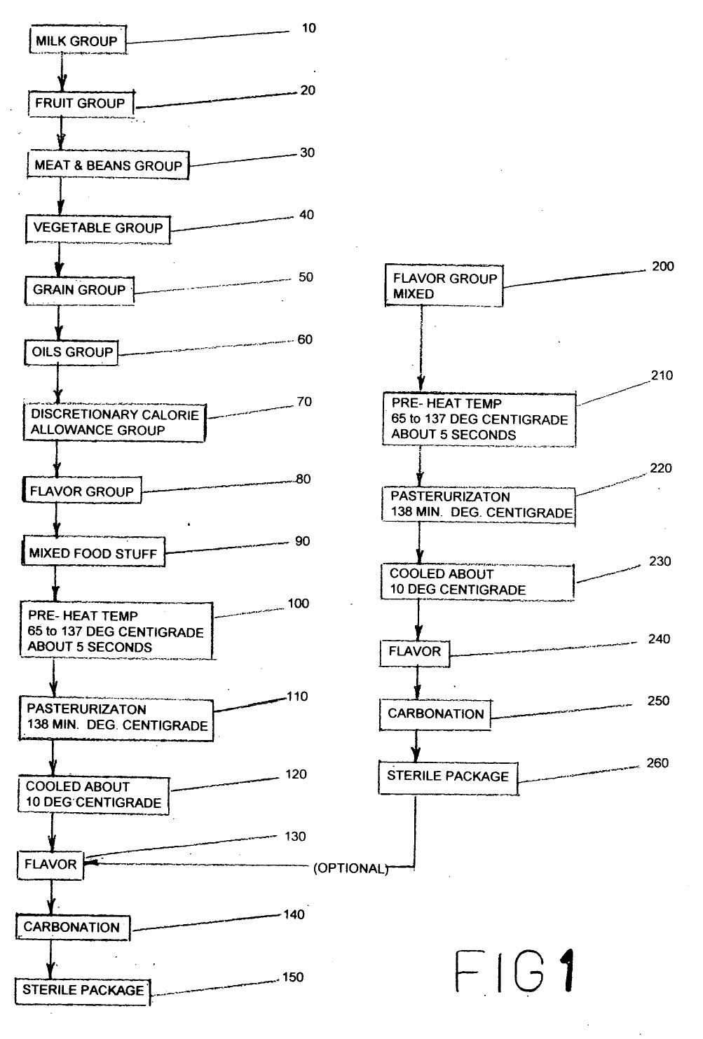

A general flow chart for the typical embodiment of the invention described herein is illustrated in FIG. 1 at 10. First, food groups 10 the milk group, 20 the fruit group, 30 the meat and beans group, 40 the vegetable group, 50 the grain group, 60 the oils group, 70 the discretion calorie allowance group, 80 the flavor group are present. All groups are assembled to meet the desired specification as defined in said claims 16 thru 24. The assembled food groups are then mixed to form a liquid, slurry, and/or puree as noted in 90 mixed food stuff. The 90 mixed food stuff is 100 preheated before it undergoes 110 pasteurization and then 120 cooled. A final 130 flavor is added. It is followed by 140 carbonation and then 150 sterile package for completion of the product can be 150 sterile packaged an considered a un-carbonated shelf stable beverage.

An optional 200 flavor group mixed per said claim 16 is present. It is 210 pre heated before it undergoes 220 pasteurization and is 230 cooled. At this time it can be if needed added to the final 130 flavor. If not added to the 130 final flavor it is then 250 carbonated. The next step is it is made ready for 260 sterile package for completion of the shelf stable beverage. Again it can be if needed added to the final 130 flavor.

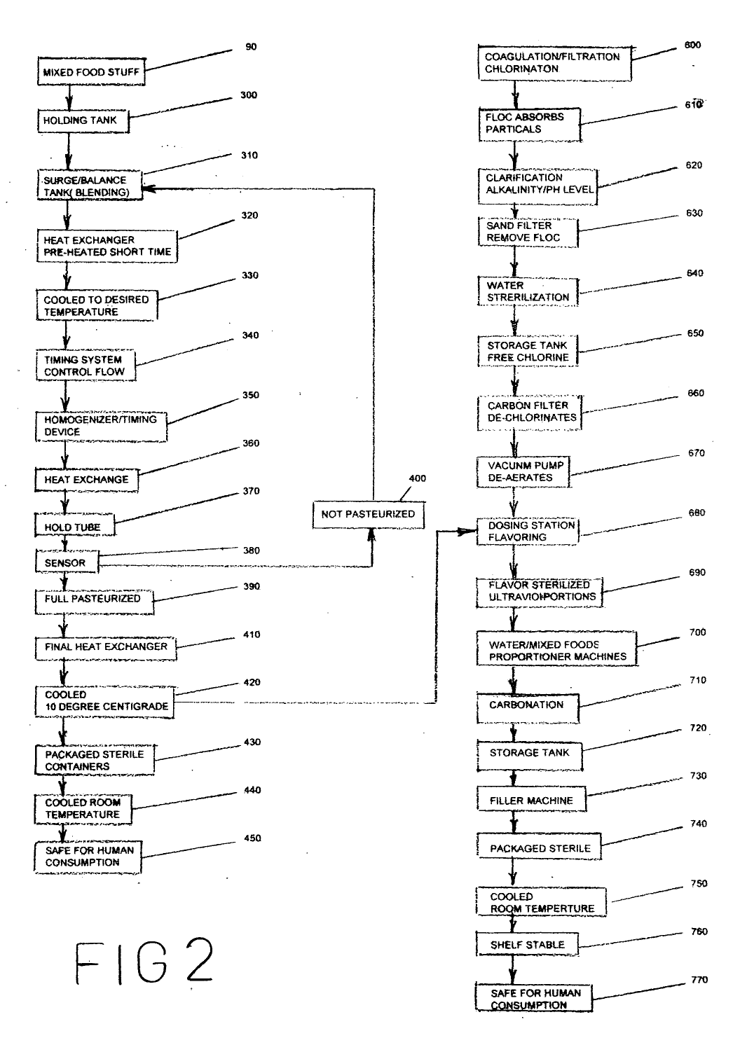

A general flow chart for the preferred embodiment of ultra high temperature pasteurization is illustrated in FIG. 2 at 90 mixed food stuff. Cold raw 90 mixed food stuff is pumped from a 300 holding tank to a 310 surge or “balance” tank. The level in the balance tank is controlled by a float which throttles back the inlet flow.

Product is then pumped/drawn into a 320 regenerative heat exchanger which heats the raw product using energy from the pasteurized product. Product temperature does not yet reach the full pasteurization temperature at this stage. Food stuff is then allowed to 330 cool to a desired temperature not to exceed about 10 degree centigrade.

Product is then pumped via the “timing system”. The 340 timing system is single device or a combination of devices which controls the maximum flow rate through the system. The performance of the systems relies on product passing through the system at a known controlled flow rate. Three said timing device machines are positive displacement pump with controlled speed drive, a 350 homogenizer also with positive displacement pump, and/or a centrifugal pump with magnetic flow.

Product is then pumped by the timing system into a 360 heat exchanger, which heats the product to full pasteurization temperature. The heating media is recycled hot water kept at temperature by direct injection of steam.

Next the product passes through the 370 “hold tube”. The length/volume of the hold tube is specifically designed so that the time required for the product to reach the end of 1.0 second or more. This is why the controlled flow rate is so critical and important. If the flow rate is allowed to increase beyond the expected rate, the product would spend less than the required seconds in the hold tube.

At the end of the 370 hold tube is a 380 sensor which measures the temperature of the product. If the 390 temperature is at or above the required temperature, and time to pasteurize the product, the product is considered 390 fully pasteurized and is permitted to pass on further in the process. If the 400 product is not up to temperature, then a divert valve returns the product to the balance tank. 390 full pasteurized product is the sent through the “other” side of the regenerative heater. The heat from the pasteurized product is transferred to the incoming raw product.

Next the product pass through a 410 final heat exchanger which 420 cools it to a temperature of less than 10 degree centigrade. Wherein the 430 finished product can be transferred and packaged into sterile containers such as bottles or cans at extremely high flow rates such as but not limited to tinplate or steel crowns with corrugated edges, twist off, or pull tabs.

The meal beverage is 440 cooled and brought to room temperature before labeling to prevent condensation from ruining the label unless labeling is affixed to the container such that it remains in tact thus meeting necessary quality standards. 450 The final product wherein is complete as a shelf stable uncarbonated beverage and determined safe for human consumption.

Also a general flow chart of the preferred embodiment of carbonation is present in FIG. 2.

Wherein the quality of the water is crucial to the success of the beverage meal. Impurities, such as suspended particles, organic matter, and bacteria, may degrade taste and color. They are removed through the traditional process of a series of 600 coagulation, filtration, and chlorination. Coagulation involves mixing a gelatinous precipitate, or floc (ferric sulphate or aluminum sulphate), into the water. The 610 flqc absorbs suspended particles, making the larger and more easily trapped by filters. During the 620 clarification process, alkalinity must be adjusted with an addition of lime to reach the desired pH level.

The clarified water is poured through a 630 sand filter to remove fine particles of floc. The water passes through a layer of sand and courser beds of gravel to capture the particles. 640 sterilization is necessary to destroy bacteria and organic compounds that might spoil the water's taste or color.

The water is pumped into a 650 storage tank and is dosed with a small amount of free chlorine. The chlorinated water remains into the storage tank for about two hours or until the reaction is complete.

Next, an activated 660 carbon filter dechlorinates the water and removes residual organic matter, much like the sand filter. A 670 vacuum pump de-aerates the water before it passes into a dosing station. The dissolve spice(s)/sugar if needed and flavor concentrates are pumped into the 680 dosing station in a predetermined sequence according to their compatibility. The ingredients are conveyed into batch tanks where they are carefully mixed. Too much agitation can cause unwanted aeration. The syrup if needed may be 690 sterilized while in the tanks, using ultraviolet radiation or flash pasteurization , which involves quickly heating and cooling the mixture. Note that fruit based syrups generally must be pasteurized.

The water and syrups are carefully combined by sophisticated machines, called 700 proportioners, which regulate the flow rates and ratios of the liquids. The vessels are pressurized with carbon dioxide to prevent aeration of the mixture. 710 carbonation is generally added to the finished product, though it may be mixed into the water at a earlier stage. The temperature of the liquid must be carefully controlled since carbon dioxide solubility increases as the liquid temperature decreases. The amount of carbon dioxide pressure used depends on the specific type of beverage meal design. For example fruit drinks require far less carbonation than mixer drinks, such as tonics which are meant to dilute some drinks.

The beverage is slightly over pressured with carbon dioxide to facilitate the movement into 720 storage tank and ultimately to the 730 filler machine.

The finished product is transferred/packaged into 740 sterile containers, such as bottles or cans at extremely high rates. The containers are immediately sealed with pressure-resistant closures, tinplated or steel crowns with corrugated edges, twist-offs or pull-tabs.

The beverage is then 750 cooled during the manufacturing process, and must be brought to room temperature before labeling to prevent condensation from ruining the labels. This is usually achieved by spraying the containers with warm water and drying them. Labels are the affixed to the containers to provide information about the brand ingredients. The final product wherein is complete as a 760 shelf stable carbonated beverage and determined 770 safe for human consumption.

What is claimed is:

1. A process for preparing, making, flavoring and designing a shelf stable carbonated beverage meal wherein taking a commercial brand named product and adding food stuff, such that combined they meet the nutritional requirements of the National School Lunch Program, the Dash Eating Plan and the United States Department of Agriculture's Dietary Guidelines for Americans, as well as various other meal types, and said meal to be prepared thereof, an example is a candy bar and adding the necessary nutrients and proteins to the candy bar such that when added together they meet the food intake requirements of the National School Lunch Program, the Dash Eating Plan and the United States Department of Agriculture food intake for Americans and taste like the brand named product, wherein this example the said candy bar.

2. The process of claim 1, wherein a daily dietary in take plan for breakfast, lunch and/or supper, is present in the amount 0.001 minimum calories per day requirements, with optional nutrients composition comprising;
(a) a requirement amount of 0.0001 grams minimum of protein, carbohydrate, monounsaturated fat, polyunsaturated fat, linoleic acid, alpha linolenic acid, total dietary fiber, potassium, sodium, chloride, carotenoids, arsenic, nickel, silicon, sulfate.
(b) a requirement amount of 0.0001 milligrams minimum of vitamin C, vitamin E, thiamin, riboflavin, niacin, vitamin B6, pantothenic acid, chorine, calcium, fluoride, iron, magnesium, phosphorus, zinc, boron, vanadium.
(c) a requirement amount of 0.0001 micrograms minimum of vitamin A, vitamin D, vitamin K, foliate, vitamin B12, biotin, chromium, copper, iodine, molybdenum, selenium, folic acid.
(d) total fat measured in grams not to exceed 30 percent of calories and, saturated fat to be less than 10 percent of proteins.

3. The process in claim 1, wherein a dietary intake plan if needed individually or in combinations of aroma, preservatives, and/or nuts are present as well as a color stable group wherein, said colorant is selected from the group consisting of FD&C Blue Dye Number 1, FD&C Red Dye Number 40, FD&C Yellow Dye Number 5, FD&C Yellow Dye number 6, FD&C green Dye Number 3, and mixtures thereof.

4. The process of claim 1, wherein a dietary intake plan of mixing food stuff at high speed and at substantially room temperature, for a period of time sufficient to form liquid, slurry, and or puree.

5. The process of claim 1, wherein a dietary intake plan, traditional meal pattern, for lunch, breakfast, and/or supper to have said required grades groups having school week averaged nutrient composition comprising;
(a) wherein for grade group pre school, a minimum calories of 517, protein of 7 grams minimum, calcium of 267 milligrams minimum, iron of 3.3 milligrams minimum, vitamin A of 150 RE minimun, vitamin C of 14 milligrams minimum, total fat not to exceed 30 percent of calories, and saturated fat to be less than 10 percent of calories.
(b) wherein for grade group kindergarten through 3, a minimum calories of 633, protein of 9 grams minimum, calcium of 267 milligrams minimum, iron of 3.3 milligrams minimum, vitamin A of 200 RE minimum, vitamin C of 15 milligram minimum, total fat not to exceed 30 percent of calories, and saturated fat to be less than 10 percent of calories.
(c) wherein for grade group 4 through 12, a minimum calories of 785, protein of 15 grams minimum, calcium of 370 milligrams minimum, iron of 4.2 milligrams minimum, vitamin A of 285 RE minimum, vitamin C of 17 milligrams minimum, total fat not to exceed 30 percent of calories, and saturated fat to be less than 10 percent of calories.
(d) wherein for grade group 7 through 12 which is optional, a minimum calories of 825, protein of 16 grams minimum, calcium of 400 milligrams minimum, iron of 4.5 milligrams minimum, vitamin A of 300 RE minimum, vitamin C of 18 milligrams minimum, total fat not to exceed 30 percent of calories, and saturated fat to be less than 10 percent of calories.

6. The process of claim 1 wherein a dietary intake plan, enhanced meal pattern, for lunch, breakfast and/or supper to have said required grade groups having school week averaged nutrients composition comprising;
(a) wherein for grades groups preschool, a minimum calories of 517, protein of 7 grams minimum, calcium of 267 milligrams minimum, iron of 3.3 milligrams minimum, vitamin A of 150 RE minimum, vitamin C of 14 milligrams minimum, total fat not to exceed 30 percent of calories, and saturated fat to be less than 10 percent of calories.
(b) wherein for grades groups kindergarten through 6, a minimum calories of 664, protein of 10 grams minimum, calcium of 286 milligrams minimum, iron of 3.5 milligrams minimum, vitamin A of 224 RE minimum, vitamin C of 15 milligram minimum, total fat not to exceed 30 percent of calories, and saturated fat to be less than 10 percent of calories.
(c) wherein for grades groups 7 through 12, a minimum calories of 825, protein of 16 grams minimum, calcium of 400 milligrams minimum, iron of 4.5 milligrams minimum, vitamin A of 300 RE minimum, vitamin C of 18 milligrams minimum, total fat not to exceed 30 percent of calories, and saturated fat to be less than 10 percent of calories.
(d) wherein for grade groups kindergarten through 3, a minimum calories of 633, a protein of 9 grams minimum, calcium of 267 milligrams minimum, iron of 3.3 milligrams minimum, vitamin A of 200 RE minimum, vitamin C of 15 milligrams minimum, total fat not to exceed 30 percent of calories, and saturated fat to be less than 10 percent of calories.

7. The process of claim 1 wherein a dietary intake plan, traditional and enhanced meal patterns, for breakfast, lunch and/or supper to have said required grade groups having school week averaged nutrients composition comprising;
(a) wherein for grade groups preschool, a minimum calories of 388, protein of 5 grams minimum, calcium of 200 milligrams minimum, iron of 2.5 milligrams minimum, vitamin A of 113 RE minimum, vitamin C of 11 milligrams minimum, total fat not to exceed 30 percent of calories, and saturated fat to be less than 10 percent of calories.
(b) wherein for grades kindergarten through 12, a minimum calories of 554, protein of 10 grams minimum, calcium of 257 milligrams minimum, iron of 3.0 milligrams minimum, vitamin A of 197 RE minimum, vitamin C of 13 milligrams minimum, total fat not to exceed 30 percent of calories, and saturated fat to be less than 10 percent of calories.
(c) wherein for grades 7 through 12 which or optional enhanced, a minimum calories of 618, protein of 12 gram minimum, calcium of 300 milligram minimum, iron of 3.4 milligrams minimum, vitamin A of 225 RE) minimum, vitamin C of 14 milligrams minimum, total fat not to exceed 30 percent of calories, and saturated fat to be less than 10 percent of calories.

8. The process of claim 1, wherein a dietary intake plan, nutrient standard menu plan and assisted nutrient standard menu plan, for lunch, breakfast and/or supper to have said established grade groups having school week averaged nutrient composition comprising;
(a) wherein for grade groups preschool, a minimum calories of 517, protein of 7 grams minimum, calcium of 267 milligrams minimum, iron of 3.3 grams minimum, vitamin A of 150 RE minimum, vitamin C of 14 milligram minimum, total fat not to exceed 30 percent of calories, and saturated fat to be less than 10 percent of calories.
(b) wherein for grade group kindergarten through 6, a minimum calories of 664, protein of 10 grams minimum, calcium of 286 milligrams minimum, iron of 3.5 milligrams minimum, vitamin A of 224 RE minimum, vitamin C of 15 milligrams minimum, total fat not to exceed 30 percent of calories, and saturated fat to be less than 10 percent of calories.
(c) wherein for grades 7 through 12, a minimum of 825 calories, protein of 16 grams minimum, calcium of 400 milligrams minimum, iron of 4.5 milligrams minimum, vitamin A of 300 RE minimum, vitamin C of 18 milligrams minimum, total fat not to exceed 30 percent of calories, and saturated fat to be less than 10 percent of calories.
(d) wherein for grade group kindergarten through 3 which is optional, a minimum calories of 633, protein of 9 grams minimum, calcium of 267 milligrams minimum, iron of 3.3 milligrams minimum, vitamin A of 200 RE minimum, vitamin C of 15 milligrams minimum, total fat not to exceed 30 percent of calories, and saturated fat to be less than 10 percent of calories.

9. The process of claim 1, wherein a dietary intake plan, nutrient standard Menu Plan and Assisted Nutrient Standard Menu Plan, for breakfast, lunch, and/or breakfast to have said established grade groups having school week averaged nutrient composition comprising;
(a) wherein for grade group, preschool, a minimum calories of 388, protein of 5 grams minimum, calcium of 200 milligrams minimum, iron of 2.5 milligrams minimum, vitamin A of 113 RE minimum, vitamin C of 11 milligrams minimum, total fat not to exceed 30 percent of calories, and saturated fat to be less than 10 percent of calories.
(b) wherein for grade group kindergarten through 12, a minimum calories of 554, protein of 10 grams minimum, calcium of 257 milligrams minimum, iron of 3.0 milligrams minimum, vitamin A of 197 RE minimum, vitamin C of 13 milligrams) minimum, total fat not to exceed 30 percent of calories, and saturated fat to be less than 10 percent of calories.
(c) wherein for grade group 7 through 12 which is optional, a minimum of 618 calories, protein of 12 grams minimum, calcium of 300 milligrams minimum, iron of 3.4 milligrams minimum, vitamin A of 225 RE minimum, vitamin C of 14 milligrams minimum, total fat not to exceed 30 percent of calories, saturated fat to be less than 10 percent of calories.

10. The process of claim 1, wherein a dietary intake plan, Nutrient Standard Menu Plan and Assisted Nutrient Standard Menu Plan, for lunch, breakfast and/or supper to have said established age groups having school week averaged nutrient considered optional with composition comprising;
(a) wherein for age group 3 through 6, minimum calories of 558, RDA for protein of 7.3 grams minimum, RDA for calcium of 267 milligrams minimum, RDA for iron of 3.3 milligrams minimum, RDA for vitamin A of 158 RE minimum, RDA for vitamin C of 14.6 milligram minimum, total fat not to exceed 30 percent of calories, and saturated fat to be less than 10 percent of calories.
(b) wherein for age group 7 through 10, minimum calories of 667, RDA for protein of 9.3 grams minimum, RDA for calcium of 267 milligrams minimum, RDA for iron of 3.3 milligrams minimum, RDA for vitamin A of 233 RE minimum, RDA for vitamin C of 15.0 milligrams minimum, total fat not to exceed 30 percent of calories, and saturated fat to be less than 10 percent of calories.
(c) wherein for age group 11 through 13, minimum calories of 783, RDA for protein of 15.0 grams minimum, RDA for calcium of 400 milligrams minimum, RDA for iron of 4.5 milligrams minimum, RDA for vitamin A of 300 RE minimum, vitamin C of 16.7 milligrams minimum, total fat not to exceed 30 percent of calories, and saturated fat to be less than 10 percent of calories.
(d) wherein for age group 14 and older, minimum calories of 846, RDA for protein of 16.7 grams minimum, RDA for calcium of 400 milligrams minimum, RDA for iron of 4.5 milligram minimum, RDA for vitamin A of 300 RE minimum, RDA for vitamin C of 19.2 milligrams minimum, total fat not to exceed 30 percent of calories, saturated fat to be less than 10 percent of calories.

11. The process of claim 1, wherein a dietary intake plan, nutrient standard menu plan and assisted nutrient standard menu plan, for breakfast, lunch, breakfast, and/or supper to have said established age groups having school week averaged nutrient considered optional with a composition composing;
(a) wherein for age group 3 through 6, minimum calories of 419, RDA for protein of 5.5 grams minimum, RDA for calcium of 200 milligrams minimum, RDA for iron of 2.5 milligrams minimum, RDA for vitamin A of 119 RE minimum, RDA for vitamin C of 11.0 milligram minimum total fat not to exceed 30 percent of calories and saturated fat to be less than 10 percent of calories.
(b) wherein for age group 7 through 10, minimum calorie of 500, RDA for protein of 7.0 grams minimum, RDA of calcium of 200 grams minimum, RDA for iron of 2.5 milligram, RDA or calcium for vitamin A of 175 RE minimum, RDA for vitamin C of 11.25 milligrams minimum, total fat not to exceed 30 percent of calories and saturated fat to be less than 10 percent of calories.
(c) wherein for age group 11 through 13, minimum calories of 588, RDA for protein of 11.25 grams minimum, RDA for calcium of 300 milligrams minimum, RDA for iron of 3.4 milligrams minimum, RDA for vitamin A of 225 RE minimum, RDA for vitamin C of 12.5 milligrams minimum, total fat not to exceed 30 percent of calories and saturated fat to be less than 10 percent of calories.
(d) wherein for age group 14 and older, minimum calories of 625, RDA for protein of 12.5 grams minimum, RDA for calcium of 300 milligrams minimum, RDA for iron of 3.4 milligrams minimum, RDA for vitamin A of 225 RE minimum, RDA for vitamin C of 14.4 milligrams minimum, total fat not to exceed 30 percent of calories, and saturated fat to be less than 10 percent of calories.

12. The process of claim 1, wherein a dietary intake plan, nutrient standard menu plan and assisted nutrient standard menu plan for lunch, supper, and/or breakfast to have said customized age groups having school week averaged nutrient considered optional and meet the following requirements;
(a) wherein the menu planner can create a customized age grouping and nutrient standards that match the grade structure of the school such that the menu planner must use more than one group for a k-12 building, so the planner would simply not customize for the grade grouping to fit the school.
(b) wherein the menu planner can customize a menu nutrient standard plan for ages 3 thru 5 for grades pre kindergarten to kindergarten, ages 6 thru 11 for grades 1 to 6, ages 12 thru 14 for grades 7 to 9, and ages 15 thru 17 for grades 10 to 12.

13. The process of claim 1, wherein an activity level for said dietary intake plan is present with a composition comprising;
(a) wherein a sedentary life style that includes only the light physical activity associated with typical day to day life and or less than 30 minute a day of at least moderate physical activity in addition to daily activities.
(b) wherein a moderately active lifestyle that includes physical activity equivalent to walking about 1.5 to 3 miles per day at 3 to 4 miles per hour in addition to the light activity associated with typical day to day life and or at least 30 minute to 60 minute a day of at least moderate physical activity in additional to daily activities.
(c) wherein an active lifestyle that includes physical activity equivalent to walking more than 3 miles per day at 3 or 4 mile per hour, in addition to the light activity associated with typical day to day life and or 60 minute or more of at least moderate physical activity in additional to daily activities.

14. The process of claim 1, wherein a daily dietary intake meal plan, for breakfast, lunch, and/or supper is present in the estimated energy requirements rounded to the nearest 200 calories per the Institute of Medicine Macronutricents Report of 2005 for age, and gender groups, at the three levels of physical activity of claim 13 with composition comprising;
(a) wherein all children, age 2 to 3 years at sedentary level requires 1000 calories per day with nutrients per said claim 2.
(b) wherein all children, age 2 to 3 years at moderately active level requires 1000 per day to 1400 calories with nutrients per said claim 2.
(c) all children, age 2 to 3 years at active level requires 1000 to 1400 calories per day with nutrients per said claim 2.
(d) wherein female ages 4 to 8 years, at sedentary level requires 1200 calories per day with nutrients per said claim 2.
(e) Wherein female ages 4 to 8 years, at moderately active level requires 1400 to 1600 calories per day with nutrients per said claim 2.
(f) wherein female ages 4 to 8 years, at active level requires 1000 to 1800 calories per day with nutrients per said claim 2.
(g) wherein female ages 9 to 13 years, at sedentary level requires 1600 calories per day with nutrients per said claim 2.
(h) wherein female ages 9 to 13 years, at moderately active level requires 1600 to 2000 calories per day with nutrients per said claim 2.
(i) wherein female ages 9 to 13 years, at active level requires 1800 to 2200 calories per day with nutrients per said claim 2.
(j) wherein female ages 14 to 18 years, at sedentary level requires 1800 calories per day with nutrients per said claim 2.
(k) wherein female ages 14 to 18 years, at moderately active level requires 2000 calories per day with nutrients per said claim 2.
(l) wherein female ages 14 to 18 years, at active level requires 2400 calories with nutrients per said claim 2.
(m) wherein female ages 19 to 30 years, at sedentary level require 2000 calories per day with nutrients per said claim 2.
(n) wherein female ages 19 to 30 years, at moderately active level requires 2000 to 2200 calories per day with nutrients per said claim 2.
(o) wherein female ages 19 to 30 years, at active level requires 2400 calories per day with nutrients per said claim 2.
(p) wherein female ages 31 to 50 years, at sedentary level requires 1800 calories per day with nutrients per said claim 2.
(q) wherein female ages 31 to 50 years, at moderately active level requires 2000 calories per day with nutrient per said claim 2.
(r) wherein female ages 31 to 50 years, at active level requires 2200 calorie per day with nutrients per claim 2.
(s) wherein female ages 51 years and older, at sedentary level requires 1600 calories per day with nutrients per said claim 2.
(t) wherein female ages 51 years and older, at moderately active level requires 1800 calories per day with nutrients per said claim 2.
(u) wherein female ages 51 years and older, at active level requires 2000 to 2200 calories per day with nutrients per said claim 2.
(v) wherein male ages 4 to 8 years, at sedentary level requires 1400 calories per day with nutrients per said claim 2.
(w) wherein male ages 4 to 8 years, at moderately active level requires 1400 to 1600 calories per day with nutrient per said claim 2.
(x) wherein male ages 4 to 8 years, at active level requires 1600 to 2000 calories per day with nutrients per said claim 2.
(y) wherein male ages 9 to 13 years, at sedentary level requires 1800 calories per day with nutrient per said claim 2.
(z) wherein male ages 9 to 13 years, at moderately active level requires 1800 to 2000 calories per day with nutrients per said claim 2.
(aa) wherein male ages 9 to 13 years, at active level requires 2000 to 2600 calories per day with nutrients per said claim 2.
(bb) wherein male ages 14 to 18 years, at sedentary level requires 2200 calories per day with nutrients per said claim 2.
(cc) wherein male ages 14 to 18 years, at moderately active level requires 2400 to 2800 calories per day with nutrients per said claim 2.
(dd) wherein male ages 14 to 18 years, at active level requires 2800 to 3200 calories per day with nutrients per said claim 2.
(ee) wherein male ages 19 to 30 years, at sedentary level requires 2400 calories per day with nutrients per said claim 2.
(ff) wherein male ages 19 to 30 years, at moderately active level requires 2600 to 2800 calories per day with nutrients per said claim 2.
(gg) wherein male ages 19 to 30 years, at active level requires 3000 calories per day with nutrients per said claim 2.
(hh) wherein male ages 31 to 51 years, at sedentary level requires 2200 calories per day with nutrients per said claim 2.t 2400 to 2600 calories with per day with nutrients per said claim 2.
(ii) Wherein male ages 31 to 51 years, at moderately active level require 2400 to 2600 calories per day with nutrient per said claim 2.
(jj) wherein male ages 31 to 51 years, at active level requires 2800 to 3000 calories per day with nutrients per said claim 2.
(kk) wherein male ages 51 years and older, at sedentary level requires 2000 calories per day with nutrients per said claim 2.
(ll) wherein male ages 51 years and older, at moderately active level requires 2200 to 2400 calories with nutrients per said claim 2.
(mm) wherein male ages 51 years and older, at active level requires 2400 to 2800 calories per day with nutrients per said claim 2
(nn) Wherein all children ages 3 thru 5 for grades pre kindergarten to kindergarten at sedentary level, moderately active level and or active level requires 1000 to 1600 calories per day with nutrients per said claim 2.
(oo) wherein all children ages 6 thru 11 for grades 1 to 6 at sedentary level, moderately active level, and or active level requires 1200 to 2200 calories per day with nutrients per said claim 2.
(pp) wherein all children ages 12 thru 14 for grades 7 to 9 at sedentary level, moderately active level and or active level requires 1600 to 2800 calories with nutrients per said claim 2.
(qq) wherein all children ages 15 thur 17 for grades 10 thru 12 at sedentary level, moderately active level, and or active level requires 1800 to 3200 calories per day with nutrients per said claim 2.
(rr) wherein for all ages human beings 0 to 10000 calories per day with nutrients per said claim 2.

15. A process of claim 1, wherein a dietary food intake plan of food groups composition comprising;
(a) a milk group, consist of all fluid milk products and foods made from milk product that retain their calcium content and has a daily requirement of 0 to 50 cups, and 1 cup equivalent composition comprising;
1. 1 cup low fat or fat-free milk, yogurt.
2. 1½ ounces of low-fat or fat-free natural cheese.
3. 2 ounces of low fat or fat-free processed cheese.
(b) a vegetable group, consist of any vegetable or vegetable juice, weather raw or cooked, fresh, frozen, canned, or dried, dehydrated, whole, cut-up or mashed and has a daily requirement of 0 to 50 cups with ½ cup equivalent composition comprising;
1. 1 cup raw leafy vegetables.
2. ½ cup of cut-up raw, or cooked, canned, frozen vegetables.
3. ½ to ¾ cup vegetable juice.
(c) a grain group, consist of any food made from wheat, rice, oats, cornmeal, barely or other grain product and has a daily requirement of 0 to 50 ounces with 1 ounce equivalent composition comprising;
1. 1 slice of bread.
2. ½ to ¼ cup or 1 ounce dry cereal.
3. ½ cup cooked rice, pasta, cereal.
(d) a meat and beans group consist of all food made from meat, poultry, fish, dry beans or peas, eggs, nuts, and seeds such that meats, poultry, fish to be cook, and beans and peas to be cooked canned or frozen with a daily requirements of 0 to 50 ounces with, 1 ounce equivalent composition comprising;
1. 1 ounce of cooked lean meats, poultry, fish.
2. ¼ cup canned, frozen, cooked dry beans, tofu, peas.
3. 1 egg.
4. 1 tablespoons peanut butter.
5. ½ to 1½ ounce nuts or seeds.
(e) a fruit group, consist of any fruit or fruit juice, fresh, canned frozen or dried, whole cup-up or pureed with a daily amount requirement of 0 to 50 cups with, ½ cup equivalent composition comprising;
1. 1 medium fruit.
2. ½ cup fresh, frozen, or canned fruit.
3. ¼ cup dried fruit.
4. ½ to 4 cup fruit juice.
(f) a oil group, consist of canola, corn, cottonseed, olive, soybean, sunflower, fish, nut, avocados oils, such that they are liquid at room temperature with a daily requirement of 0 to 50 grams with, 1 teaspoon equivalent composition comprising;
1. 1 tablespoon low fat mayonnaise.
2. 2 tablespoons of light salad dressing.
3. 1 teaspoon vegetable oil.
4. 1 teaspoon soft margarine.
(g) a discretionary calorie allowance group, with a daily requirement of 0 to 567 calories, and or 0 to 50 tablespoon of sugar per week with, 1 tablespoon sugar equivalent composition comprising;
1. ½ ounce jelly beans.
2. 8 ounces lemonade.
3. 1 table spoon jelly or jam.

16. a flavor, a commercial brand named product, taste group, wherein a dietary intake plan including but not limited to a composition comprising;
(a) soft drinks composition comprising;
1. Coca Cola Zero.
2. Diet Dr Pepper.
3. Diet Pepsi.
(b) sport drinks
1. Gatorade
2. Powerade.
(c) coffee composition comprising;
1. Maxwell House.
2. Flogers.
3. Sanka.
(d) beer non-alcohol composition comprising;
1. Miller Lite
2. Bud Light.
3. Coors Light.
(e) wine non alcohol composition comprising;
1. Spumante's
2. Morgan David
3. Boones Farm
4. Ripple
(f) hard liquor non alcohol composition comprising;
1. Jim Daniel's
2. Seagram
3. Chavis Regal
4. Jim Beam.
(g) ice creams composition comprising;
1. Belmont's lemon.
2. Blue Belle's strawberry.
3. Carvel's kiwi.
(h) Arby's menu composition comprising;
1. Biscuit With Butter.
2. Biscuit With Ham.
3. Biscuit With Sausage.
4. Croissant With Bacon.
5. Arby's Melt With Cheddar.
6. Arby-Q.
7. Beef N′ Cheddar.
8. Big Montana.
9. Super Roast Beef.
10. French dip sandwich.
11. Philly Beef N′ Swiss.
12. Roast Beef & Swiss.
13. Roast Ham & Swiss.
(i) Burger King's menu composition comprising;
1. Biscuit With Egg.
2. Whopper With Mayo.
3. Whopper With Cheese.
4. Cheeseburger.
5. Hamburger.
6. Chicken Tenders sandwich.
7. French Fries.
8. Onion rings.
9. Bacon Double Cheeseburger.
(j) Domino's pizza menu composition comprising;
1. Classic Hand Tossed Cheese.
2. Classic Hand Tossed Pepperoni.
3. Crunchy Thin Crusted Cheese.
4. Crunch Thin Crusted Pepperoni.
5. Ultimate Deep Dish Cheese.
6. Ultimate Deep Dish Pepperoni.
(k) Dunkin′ Donuts' menu composition comprising;
1. Berry, Berry.
2. Banana Nut.
3. Honey Bran Raisin.
4. Apple Cinnamon Pecan.
5. Sugar Raised Yeast.
6. Chocolate Coconut Cake.
7. Glazed Donut.
(l) Jack in the Box's menu composition comprising;
1. Sausage Biscuit.
2. Bacon Ultimate Cheeseburger.
3. Chicken and Fish.
4. Monster Taco.
5. Jumbo Jack.
(m) KFC's menu composition comprising;
1. Original Recipe chicken.
2. Extra Crispy Chicken.
3. Hot & Spicy Chicken.
4. Twister.
5. Honey Barbarque Strips
(n) McDonald's menu composition comprising;
1. Big Mac.
2. Big N′ Tasty.
3. Crisp Chicken.
4. Filet-O-Fish.
5. Chicken McGrill.
6. French fries.
7. Chicken McNugets.
8. Cheeseburger.
(o) Panda Express's menu composition comprising;
1 Black Peppered Chicken.
2 Orange Chicken.
3 Chicken with Mushrooms.
4 Spicy Chicken with Peanuts.
5 Chicken with String Beans.
(p) Pizza Hut's menu composition comprising;
1. Cheese Topping.
2. Beef Topping.
3. Ham Topping.
4. Italian Sausage.
5. Polish Sausage.
6 Pork Topping.
7 Meat Lover's.
8 Pepperoni Topping.
9 Supreme Topping.
(q) Subway's menu composition comprising;
a. Cold Cut Trio.
b. Seafood and Crab.
c. Stake and Cheese.
d. Roasted Chicken Breast.
e. Turkey Bacon and Ham.
f. Asiago Ceasar Chicken.
g. Southwest Stake & Cheese.
h. Horseradish Stake & Cheese.
i. Subway melt.
j. Turkey Breast.
(r) Taco bell's menu composition comprising;
1. Taco Supreme.
2. Bean Burrito.
3. Fiesta Burrito.
4. Double Burrito Supreme Beef.
5. Double Burrito Supreme Chicken.
6. Double Burrito Supreme Stake.
7. Grilled Stuff Burrito Beef.
(s) Wendy's menu composition comprising;
1. Classic Single.
2. Breaded Chicken Fillet.
3. Cheeseburger.
4. Spicy chicken Sandwich.
(t) Mars' menu composition comprising;
1. Three Musketeers.
2. Bounty.
3. Forever Yours.
4. Mars Bar.
5. Milky Way.
6. M-Azing.
7. Twix.
(u) Nestle's menu composition comprising;
1. 100 grand bar.
2.Aero.
3. Aero Caramel.
4. After Eight.
5. Baby Ruth.
6. Big Turk.
7. Butter Finger.
8. Caramel Crunch.
9. Carlos V.
10. Chokito.
11. Coffee Crisp.
12. Coffee Crisp Orange.
13. Cookie n′ Creme.
14. Kit Kat.
(v) Hershey's menu composition comprising;
1. 5^{th} Avenue.
2. Almond Joy
3. Fast Break.
4. Hershey Almond Toffee Bar.
5. Junior Mints.
6. Kit Kat.
7. Take 5.
8. Zero Bar.
(w) Cadbury-Schwepps' menu composition comprising;
1. Bournville.
2. Breakaway.
3. Cadbury Marble.
4. Cadbury's Fudge.
5. Caramello.
6. Caramilk.
7. Cherry Ripe.
8. Fruit and Nut.

17. The process of claim 1, wherein that selecting one or a combination of options of menu type and/or its individual items from said claim 2 thru 14, and adding at least one option or combination of options of said claim 15, milk group, and taste group, of said claim 16 thereof is present in the amount to contribute to the whole of a meal design.

18. The process of claim 1, wherein that selecting one or a combination of options of menu type, and/or its individual items from said claim 2 thru 14, and adding at least one option or combination of options of said claim 15, vegetable group, and taste group of said claim 16 thereof is present in the amount to contribute to the whole of a meal design.

19. The process of claim 1 wherein that selecting one or a combination of options of menu type, and/or its individual items from said claim 2 thru 14, and adding at least one option or combination of options of said claim 15, grain group, and taste group of said claim 16 thereof is present in the amount to contribute to the whole of a meal design.

20. The process of claim 1, wherein that selecting at least one or a combination of options of menu type, and/or its individual items from said claim 2 thru 14, and adding at least one option or combination of options of said claim 15, meat and beans group, and taste group of said claim 16 thereof is present in the amount to contribute to the whole of a meal design.

21. The process of claim 1 wherein that selecting at least one or a combination of options of menu type, and/or its individual items from said claim 2 thru 14, and adding at least one option or combination of options of said claim 15, fruit group, and taste group of said claim 16 thereof is present in the amount to contribute to the whole of a meal design.

22. The process of claim 1, wherein that selecting at least one or a combination of options of menu type, and/or its individual items from said claim 2 thru 14, and adding at least one option or combination of options of said claim 15, oil group, and taste group of said claim 16 thereof is present in the amount to contribute to the whole of a meal design.

23. The process of claim 1, wherein that selecting at least one or a combination of options of menu type, and/or its individual items from said claim 2 thru 14, and adding at least one option or combination of options of said claim 15, discretionary calorie group allowance, and taste group of said claim 16 thereof is present in the amount to contribute to the whole of a meal design.

24. The process of claim 1, wherein that selecting at least one or a combination of options of menu type and/or its individual items from said claim 2 thru 14, and adding at least one option or combination of options of said claim 16 flavor and taste group, and at least one option or combination of options of said claim 15 thereof in the amount to contribute to the whole of a meal design.

25. The process of claim 1, wherein the mixed food groups of said claims 17 thru 24 are combined with if needed a carbonated flavor group of said claim 16 and/or additives of said claim 3 which includes if needed colorants and aromas to form liquid, slurry, puree per said claim 4.

26. A method of carbonating a self stable, preheated, pressurized, pasteurized, heat treat mixed flavor group of said claim 16 to a level of carbonation while not de-stabilizing the shelf stable pre-heat mixed flavor group of said claim 16 comprising;
(a) mixing flavor group of said claim 16 at room temperature per said claim 4.
(b) preheating at least one or a combination of any of mixed flavor group items of said claim 16 within a temperature and time range of at least 85 to 137 centigrade for a period not to exceed 5 seconds.
(c) heating at least one or a combination of any items of mixed flavor groups of said claim 16 wherein a ultra high temperature and time range of 138 minimum degrees centigrade for about 1.0 to 2.0 second where it is held at a pressure sufficient for killing and sterilizing, pathogens, microorganisms and bacteria and flavoring the flavor group of said claim 16 such flavoring ingredients and preservative ingredients are added sequentially to the flavoring group of said claim 16 and each ingredient is mixed before the next ingredient is added.
(d) cooling the flavor group of said claim 16 to a temperature of less than about 10 degree centigrade. subjecting the cooled mixed flavor of said claim 16 to pressurized carbon dioxide from a carbonator at sufficient pressures and for a sufficient time such that the taste and mouth feel of carbonated mixed flavor group of said claim 16 is no longer that of the un-carbonated mixed flavor group of said claim 16, provided that the designed amount of volume of carbon dioxide is dissolved in the mixed flavor group of said claim 16 at a food safe level of about 3 to 8 vols.
(e) packaging the said carbonated mixed flavored group of said claim 16 in shelf stable closed containers capable of retaining a degree of carbonation without refrigeration wherein the step of flavoring comprising;
1. adding if needed sugar or corn syrup and/or foodstuff discretionary calorie allowance as per said claim 16 mixing for a minimum of 5 minutes.
2. adding if needed flavoring of flavor group of said claim 16 and colors and additives of claim 3 thereof mixing for minimum of 5 minutes
3. adding if needed calcium supplementation and vitamin supplementation and mixing for a minimum of 2 minutes.
4. adding if needed phosphoric acid and citric acid and mixing for a minimum of 2 minutes.
5. adding if needed preservatives and stabilizers and mixing for a minimum of 5 minutes, wherein the calcium supplementation includes benzoate, the preservations includes benzoic acid and the stabilizers include kappa-carageenan.
(f) ultra high temperature heated sterile and flavored un-carbonated mixed foodstuff can be cooled and packaged sterile in shelf stable closed containers capable of storage without refrigeration.

27. The process of claim 1, wherein methods of pasteurizing shelf stable mixed food stuff composition comprising;
(a) high temperature short time pasteurization requires heating food stuff to 72 centigrade degrees for 15 seconds.
(b) ultra pasteurization requires heating food stuff to a temperature of 89 degrees centigrade for 1.0 seconds.
(c) ultra pasteurization requires heating food stuff to a temperature of 90 degrees centigrade for 0.5 seconds.
(d) ultra pasteurization requires heating food stuff to a temperature of 94 degrees centigrade for 0.05 seconds.
(e) ultra pasteurization requires heating food stuff to a temperature of 100 degrees centigrade for 0.01 seconds.
(f) ultra high temperature sterilization requires heating food stuff to a temperature of 138 degree centigrade for 2.0 seconds.
(g) ultra high temperature sterilization requires heating food tuff to a temperature of 141 degrees centigrade for 1.0 seconds.

28. A method according to claim 1 wherein at least one method of carbonating a shelf stable mixed foodstuff comprising;
(a) Mixing food group of said claim 15 at room temperature per said claim 4.
(b) mixed foodstuff of said claim 25 is pumped from a holding container/tank to a surge/balance tank, in which the unit is controlled by a device that allows throttling the inlet flow.
(c) mixed foodstuff of said claim 25 is pumped/drawn into a regenerative heat exchanger or comparable industry standard apparatus which heats the mixed food stuff for a predetermined time of at least 65 to 137 degrees centigrade for a time not to exceed 5 seconds and, not to full pasteurization temperature at this stage.
(d) mixed food stuff of said claim 25 wherein is cooled to a temperature less than about 10 degrees centigrade .
(e) mixed foodstuff of said claim 25 wherein is pumped via a timing system such that the timing system is a single device or combination of devices which controls the maximum flow rate through the system, and the performance of the system relies on the mixed foodstuff passing through the system at a known controlled flow rate.
(f) mixed foodstuff of said claim 25 wherein having at least one said timing device of which to be but not limited to a positive displacement pump with controlled speed drive, a homogenizer, or a centrifugal pump with magnetic flow meter controller.
(g) mixed foodstuff of said claim 25 is pumped by the timing system into a heat exchanger which heats the mixed foodstuff to the full pasteurization temperature, and the heating media can be but not limited to recycled hot water kept at desired temperature by direct injection of steam.
(h) mixed food stuff of said claim 25 wherein passes through a hold tube of which the length/volume of the hold tube is specifically designed so that the time required for the mixed foodstuff to reach the end is the number of seconds required for full pasteurization based on temperature and time.
(i) mixed food stuff of said claim 25 wherein at the end of said hold tube a sensor measures the temperature such that if the temperature is at or above the required temperature, then the mixed foodstuff is consider fully pasteurized and is permitted to pass on further into the next process and too if mixed foodstuff is not up to temperature it is diverted back to the container or surge/balance tank and recycled.
(j) mixed foodstuff of said claim 25 wherein passes through a final heat exchanger which cools said foodstuff to a storage temperature to about less than 10 degree centigrade, generally with a cooling media of but not limited to chilled water, air blown, or food grade glycol.
(k) mixed foodstuff of said claim 25 wherein a process of clarifying the water through a process of series of coagulation, filtration and chlorination.
(l) mixed foodstuff of said claim 25 wherein coagulation involves mixing a gelatinous precipitate or floc, ferric sulfate or aluminum sulfate, into the water such that the floc absorbs suspended particles, making them larger and more easily trapped by filters.
(m) mixed foodstuff of said claim 25 wherein during the clarification process, alkalinity must be adjusted with an addition of lime or other equivalent device to reach the desired pH level.
(n) mixed foodstuff of said claim 25 wherein the clarified water is poured through a sand filter or equivalent device to remove fine articles of floc.
(o) mixed foodstuff of said claim 25 wherein sterilization is necessary to destroy bacteria and organic compounds that might spoil the water's taste or color.
(p) mixed foodstuff of said claim 25 wherein the water is pumped into a storage tank and dosed with a small amount of free chlorine for about 2 hours or until the reaction is completed.
(q) mixed foodstuff of said claim 25 wherein an activated carbon filter de-chlorinates the water and removes residual organic matter, and a vacuum pump de-aerates the water before it passes into a dosing station.
(r) mixed foodstuff of said claim 25 wherein mixing the ingredients or flavoring concentrates of the mixed foodstuff per said claims 24 and/or 25 are pumped into the dosing station in a predetermined sequence according to their compatibility and conveyed into batch tanks where they are mixed.
(s) mixed foodstuff of said claim 25 wherein the mixed flavored foodstuff may be sterilized while in the tanks, using ultraviolet radiation or flash pasteurization, or some other method which involves quickly heating and cooling the mixture.
(t) mixed foodstuff of said claim 25 wherein the water and mixed foodstuff flavor are combined by sophisticated machines called proportions, which regulate the flow rates and ratios of the liquids and are pressurized with carbon dioxide to prevent aeration of mixture.
(u) mixed foodstuff of said claim 25 wherein carbonation is added to the finished product, thought it may be mixed into the water at an earlier stage the temperature of the liquid must me carefully controlled since carbon dioxide solubility increases as the liquid temperature decreases, therefore the amount of carbon depends on the type of drink.
(v) mixed foodstuff of said claim 25 wherein is slightly over pressured with carbon dioxide to facilitate the movement into storage tanks and ultimately to the filler machine.
(w) mixed foodstuff of said claim 25 wherein the finished sterile product is transferred into containers, such as cartons, bottles or cans at extremely high flow rates and the containers are immediately sealed with pressure-resistant closures, such as but not limited to tinplate or steel crowns with corrugated edges, twist off, or pull tabs.
(x) mixed foodstuff of said claim 25 wherein is cooled and brought to room temperature before labeling to prevent condensation from ruining the label unless labeling is affixed to the container such that it remains in tact thus meeting necessary all quality standards.
(y) mixed foodstuff of said claim 25 wherein is complete as a shelf stable beverage and determine safe for human consumption.
